(19) United States
(12) Patent Application Publication
(10) Pub. No.: US 2025/0006047 A1
(43) Pub. Date: Jan. 2, 2025

(54) A METHOD, DEVICE, SYSTEM AND COMPUTER PROGRAM

(71) Applicant: Sony Semiconductor Solutions Corporation, Kanagawa (JP)

(72) Inventors: Salvatore FINATTI, Basingstoke (GB); Antonio AVITABILE, Basingstoke (GB); Michele LAPRESA, Basingstoke (GB)

(21) Appl. No.: 18/703,600

(22) PCT Filed: Oct. 18, 2022
(86) PCT No.: PCT/GB2022/052648

§ 371 Date: Apr. 22, 2024

(30) Foreign Application Priority Data
Nov. 11, 2021 (GB) 2116201.1

(51) Int. Cl. G08G 1/01; G06V 20/10; G08G 1/04

(52) U.S. Cl. CPC G08G 1/0133; G06V 20/176; G08G 1/0116; G08G 1/0141; G08G 1/04

(57) ABSTRACT

Described is a method of determining a risk value at a real-world location, the method comprising: receiving data from an image of the location captured by a camera; determining, from the data, the presence of one or more objects in the image; determining a plurality of parameters for each of the objects in the image; and determining the risk value based upon the plurality of parameters.

### BACKGROUND

### Field of the Disclosure

The present technique relates to a method, device, system and computer program.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present technique.

Modern towns and cities are becoming increasingly complex environments to navigate around. The range and number of vehicles on the roads is increasing and the number of pedestrians on sidewalks and crossing the roads is increasing. Moreover, with many more vehicles on the road and the prevalence of navigation systems in vehicles, drivers are becoming increasingly distracted.

This means that there is an increased risk of vehicles crashing into other vehicles or, more seriously, into pedestrians.

It is an aim of the disclosure to address this issue by quantifying this risk.

### SUMMARY

According to embodiments of the disclosure, there is provided a method of determining a risk value at a real-world location, the method comprising: receiving data from an image of the location captured by a camera: determining, from the data, the presence of one or more objects in the image: determining a plurality of parameters for each of the objects in the image; and determining the risk value based upon the plurality of parameters.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a device 100 according to embodiments of the present disclosure;

FIGS. 2A and 2B show a real-world scene and a schematic view of a deployment of embodiments of the disclosure;

FIG. 3 shows an example situation 300;

FIG. 4 shows a table associating various objects detected in FIG. 3 with a risk value at a particular time;

FIG. 5A shows a table to establish the value of the risk parameter when the detected object is a car;

FIG. 5B shows a table to establish the value of the risk parameter when the detected object is a lorry;

FIG. 5C shows a table to establish the value of the risk parameter when the detected object is a person;

FIG. 6 shows three permanent mitigation techniques;

FIG. 7 shows the real-world scene of FIG. 2B with the mitigation technique installed;

FIG. 8 shows a central control system 800 according to embodiments of the disclosure;

FIG. 9A shows a method carried out in the audio/video capturing device according to embodiments; and

FIG. 9B shows a method carried out in the central control system according to embodiments.

### DESCRIPTION OF THE EMBODIMENTS

Referring now to the drawings, wherein like reference numerals designate identical or corresponding parts throughout the several views.

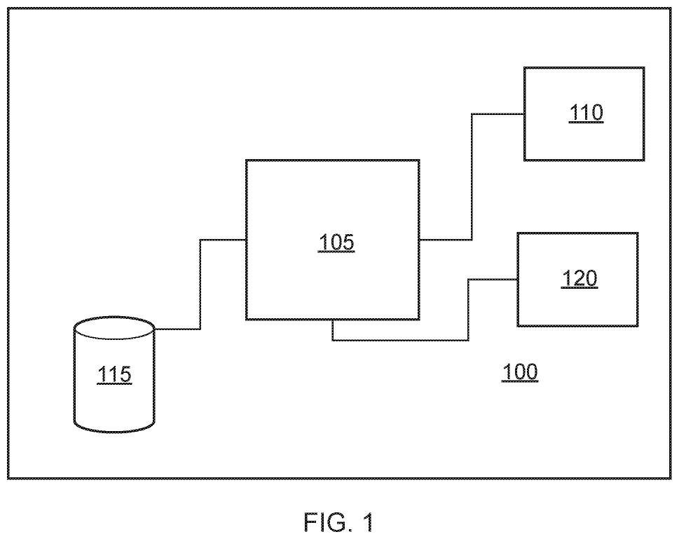

FIG. 1 shows an audio/video capturing device 100 according to embodiments of the disclosure. The audio/video capturing device 100 includes a sensor 110. The sensor 110 may be composed of sensor circuitry which is, in embodiments, semiconductor circuitry. The sensor 110 is configured to capture audio/video information of a real-world scene at a first time and a second time. In embodiments, the sensor 110 may capture audio information and/or video information. In other words, the sensor 110 may, in embodiments, capture images (which may be still images or video) only or may capture audio only or may capture both audio and images.

The audio/video capturing device 100 also includes communication circuitry 120. The communication circuitry 120 is configured to provide, over a network, metadata describing the event and a unique geographical position of the event. This will be described later. Of course, the disclosure is not limited to this and other data may be provided over the network by the communication circuitry 120. The network may be a wired network, or a wireless network. For example, the communication circuitry 120 may allow data to be communicated over a cellular network such as a 5G network, or a Low Earth Orbit Satellite internet network or the like. This network may be a Wide Area Network such as the Internet or may be a Private Network.

In embodiments, the communication circuitry 120 includes Global Positioning System (GPS) functionality. This provides a unique geographical position of the audio/video capturing device 100. Of course, the disclosure is not so limited and any kind of mechanism that provides a unique geographical position of the audio/video capturing device 100 is envisaged. In other words, the unique geographical position may be a locally unique position (such as a location within a particular city or on a particular network).

Moreover, in embodiments, the audio/video capturing device 100 may use the characteristics of the sensor 110 to determine a location that is captured by a camera within the audio/video capturing device 100. This enables the audio/video capturing device 100 to calculate the unique geographical location captured by the camera which may be provided over a network. One such technique to establish the location knowing the geographic position of the audio/video capturing device 100 is to geo-reference the image captured by the audio/video capturing device 100.

The operation of the audio/video capturing device 100 is, in embodiments, controlled by processing circuitry 105. The processing circuitry 105 may be formed from semiconductor material and may be an Application Specific Integrated Circuit or may operate under the control of software. In other words, the processing circuitry 105 may operate under the control of software instructions stored on storage medium 115. The processing circuitry 105 is thus connected to the sensor 110 and the communication circuitry 120.

Additionally connected to the processing circuitry 105 is the storage 115. The storage 115 may be semiconductor storage or optically or magnetically readable storage. The storage 115 is configured to store software code according to embodiments therein or thereon.

Although the aforesaid sensor 110, communication circuitry 120, processing circuitry 105 and storage 115 is described as functionally different, it is envisaged that, in embodiments, these may all form part of the same circuitry. In other words, the audio/video capturing device 100 may comprise circuitry to perform the various functional steps.

In embodiments, the audio/video capturing device 100 is an IMX500 or IMX501 produced by Sony Corporation R or equivalent where a sensor (such as an image sensor) is provided in a device with processing capability. In some embodiments, such a sensor may be connected to the storage 115 over a network (such as a cellular network) rather than utilising on-board storage.

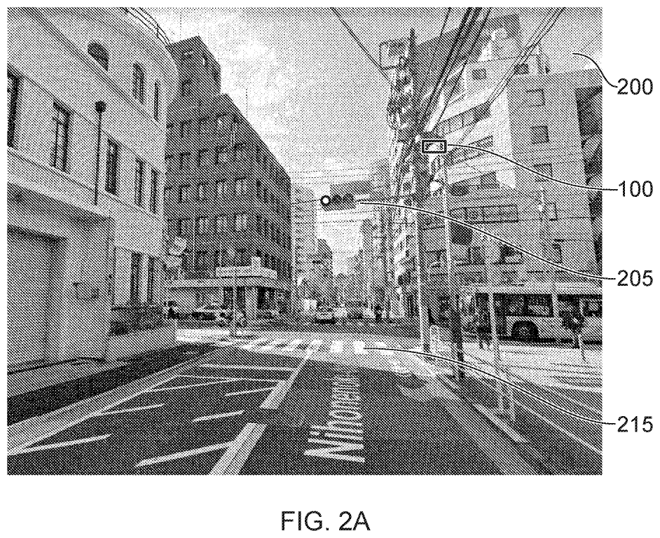

Referring to FIG. 2A, a deployment 200 of the audio/video capturing device 100 according to embodiments is shown. This deployment 200 is at a real-world location and is, in this example, located at a crossroads in a city. In embodiments, the audio/video capturing device 100 is provided in a street light. However, of course, the disclosure is not so limited and the audio/video capturing device 100 may be located anywhere. For example, the audio/video capturing device 100 may be located on a building or in a piece of street furniture such as a traffic light, bench or the like. The advantage of locating the audio/video capturing device 100 in a piece of street furniture such as a street light or a traffic light is that electricity is already provided. However, the audio/video capturing device 100 may also be battery powered in embodiments.

Located at the crossroads is a traffic light 205. As noted above, a traffic light is an example of street furniture. In embodiments, the traffic light 205 is operational and showing a red light. In addition, a pedestrian crossing 215 is shown in FIG. 2A.

FIG. 2B shows a simplified aerial view of the real-world scene shown in FIG. 2A. In particular, the traffic light 205 and the audio/video capturing device 100 is shown. In real-world scene in FIG. 2A is captured from direction A shown in FIG. 2B. The Field of View (FOV) of the audio/video capturing device 100 is shown in FIG. 2B.

The audio/video capturing device 100 captures audio and/or video information from the real-world scene. In the situation where the audio/video capturing device 100 is located in a street light, the audio/video capturing device 100 is located above street level. This increases the area that is covered by the audio/video capturing device 100. In other words, by mounting the audio/video capturing device 100 above the street level, the audio/video capturing device 100 captures more of the real-world scene than if it were mounted at street level. In addition, the likelihood of an object obscuring the field of view of the audio/video capturing device 100 is reduced by mounting the audio/video capturing device 100 above street level.

The audio and/or video information of the location is captured. The audio and/or video information may be captured over a short period of time such as 10 seconds or may be captured over a longer period of time such as one hour or may be a snap-shot of audio and/or video information such as a single frame of video. In instances, the audio and/or video information is captured at the same time every day, or at other intervals such as during rush hour or the like.

From the captured audio and/or video information, the processing circuitry 105 extracts data from the image. In embodiments, the data may be the image data from the image sensor such as RAW data or the like. Before this image data is sent over the network, the image data may be encrypted or in some way obfuscated or anonymised to ensure the content of the image data does not show individuals or specific objects in the image.

However, in embodiments, the data may be metadata extracted from the image by the processing circuitry 105. In this context, metadata is data that describes the content of the image and is smaller in size than the entire image. In order to achieve this, the processing circuitry 105 performs object detection on the image data. The object detection is performed, in embodiments, to detect vehicular objects such as cars, lorries, buses and to identify the different types of vehicular objects in the captured images. In this context, a type of vehicular object is the category of vehicle. The category of vehicle may be granular such as the Euro NCAP Class, US EPA Size Class or based on ISO 3833-1977 for cars or the various category of Heavy Goods Vehicles, lorries, buses, coaches. In embodiments, the category of vehicle may be less granular and may be defined by the vehicle being a car, bus, coach, lorry, motorcycle, bicycle or the like.

In embodiments, in addition or alternatively to identifying the different types of vehicular object, the object detection may detect people. In embodiments, the object detection may detect the different types of people in the images. For example, the object detection may detect whether the person is a baby, child, adult. In embodiments, the approximate age or the person may be detected using Artificial Intelligence, or whether the person is using a mobility aid such as a wheelchair, walking stick or the like.

After the processing circuitry 105 has performed the object detection, the data is then output over the network using the communication circuitry 120. The data may be output as the objects are detected or may be collated in the storage 115 for a period of time and then output periodically. In either case, a time stamp identifying the time the particular object was detected may be output.

In embodiments, the processing circuitry 105 may create a table such as table I explained below that associates the type of object with a particular time or time period. This allows the number of the different types of objects appearing at the location over a time period to be determined.

In embodiments, the movement performed by the detected object is detected. This may include the direction of movement of the object such as whether a vehicle is turning a corner, at an intersection in the road and whether the intersection has good or poor visibility or whether a pedestrian is crossing the road. In embodiments, this may include the speed of movement performed by the detected object. This may include the speed of travel of a vehicle, change of speed of vehicle (such as hard acceleration or deceleration or braking), or whether a pedestrian is running, meandering or walking. This information may be provided in addition to the detected object.

It should be noted that although the foregoing describes the object detection being carried out in the audio/video capturing device 100, the disclosure is not so limited and the detection of the objects in the image may be carried out at a different part of the network over which an image from the image sensor is sent. In other words, the image of the location captured by the camera (image sensor) is provided to a different part of the network for processing. This reduces the processing burden on the audio and/or video capturing device 100.

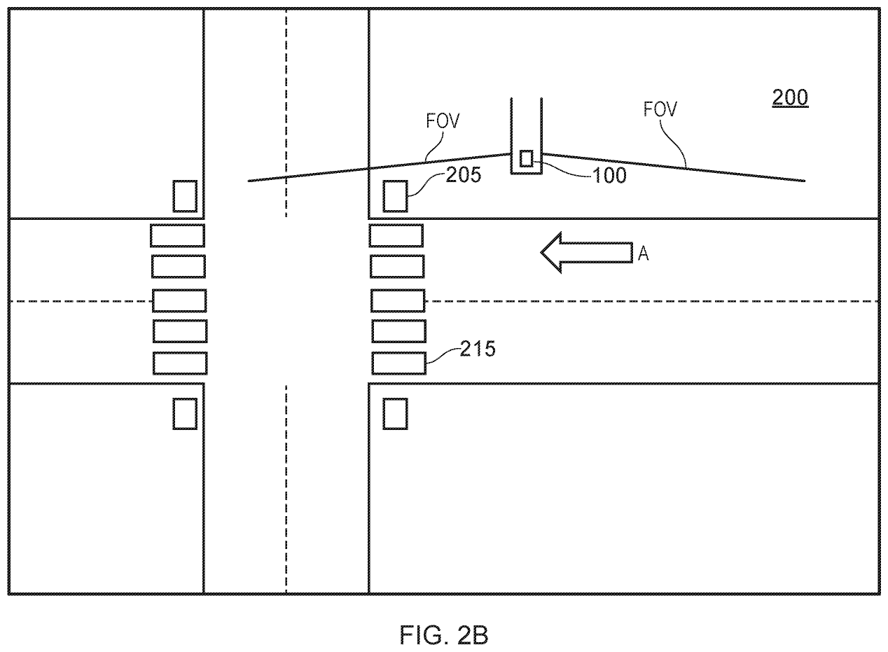

Referring to FIG. 3, an example situation 300 is shown. In the example of FIG. 3, the two roads are identified as “Road A” and “Road B”. Road A traverses FIG. 3 in a North-South direction and Road B traverses FIG. 3 in an East-West direction. The compass in the bottom right hand corner of FIG. 3 shows the Northerly direction as “N”, the Easterly direction as “E”, the Southerly direction as “S” and the Westerly direction as “W”.

Many vehicles are detected from the images captured by the audio/video capturing device 100. In the example, arrows have been provided to show the direction of the travel of each vehicle. In the example of FIG. 3, cars 310, 312, 313, 315, 316 and 318 are shown. This means that the object detected is a car. As is appreciated many different types of cars are made and sold and these are typically classified by the size of the car. For example, a car may be a Sport Utility Vehicle (SUV) type or a compact, or mid-sized or sedan or the like. Each type of car tends to possess certain characteristics. For example, an SUV tends to be heavier than a compact car, but has better visibility as the driver is positioned higher in the cabin. This means that although the SUV is larger, maneuvering an SUV is typically easier than a maneuvering a compact car.

Additionally shown are truck 311 and articulated lorry 314 (referred to as “lorry” hereinafter). In the embodiments of FIG. 3, car 316 is turning at the intersection and the lorry 314 is turning at the intersection.

In order to determine the type of vehicle, in embodiments, Artificial intelligence is used. In this case, the detected object is compared with a database of known vehicle types and the closest type of vehicle is provided. In other embodiments, the brand of vehicle and the type of vehicle may be established from car badges adorning the vehicle. Classification of type of vehicle may also be performed using “Automatic Number Plate Recognition” (ANPR) where the vehicle registration information is detected and is compared with a national database of car registration information which provides the type of vehicle.

Additionally shown in FIG. 3 are people 355. Many of the people 355 in FIG. 3 have disembarked a bus (not shown) at bus stop 350. In the embodiments of FIG. 3, the people 355 are school children heading for school 305. In FIG. 3, several of the people 355 have been identified. These are person 1 360A, person 2 360B and person 3 360C.

In embodiments, the detection of a person uses similar techniques to those used to detect other kinds of objects such as vehicles. In particular, once a person is detected (i.e. the object is a person), the type of person is detected and the action performed by the person is then detected. In embodiments, the type of person may be defined by their age. For example, the approximate age of the person is detected. This may be achieved by reviewing the clothes worn by the person, the height of the person or the like. For example, if the person is wearing a school uniform, it is expected that the person is a child or if the person has grey hair, then the person is unlikely to be a child. In embodiments, the type of person may be identified by the job they do. For example, the type of person may be a police officer, fire fighter, or the like. In embodiments, the type of person may be defined by their mobility. For example, a person who needs assistance such as a walking stick may be more at risk of an accident crossing a busy road than a person who needs no such assistance.

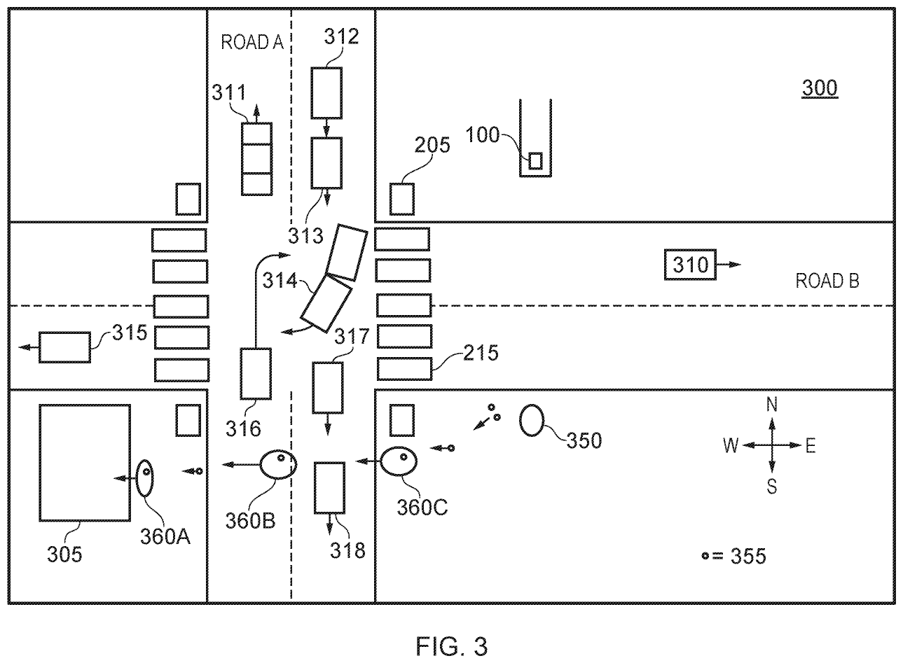

FIG. 4 shows a table associating various objects detected in FIG. 3 with a risk value at a particular time. In FIG. 4 several of the objects in FIG. 3 are noted and associated with a risk value. It is noted that, in reality, all of the objects in FIG. 3 will be noted and associated with a risk value but a subset of those are shown in FIG. 4 for brevity.

In FIG. 4, the car 313 is located at position (x1, y1). In embodiments, this location is the geographical position of car 313 at the particular time. This is calculated from the image as the geographic position of the audio/video capturing device 100 is known and the field of view of the camera is known and so by determining the position of the car 313 in the image, it is possible to determine the geographical position of the car 313. The direction of travel of the car 313 is determined from images captured immediately prior to the predetermined time. In this case, the car 313 is travelling south down Road A. The speed of car 313 is also determined from images of the car 313 captured prior to the predetermined time. In particular, it is possible to determine the speed of car 313 from the distance travelled by car 313 over a short time period. In embodiments, other mechanisms for determining speed of an object are also envisaged. For example, a LIDAR or Radar speed measuring device may be integrated into or separate to the audio/video capturing device 100.

The type of object is detected and stored in the table of FIG. 4. In particular, car 313 is detected and the car 313 is classified as a compact car. As noted previously, this classification may be made using ANPR from the vehicle registration information or may be detected by comparing the captured image of car 313 with other captured images of cars which show various types of car and the type of car 313 is established using artificial intelligence or the like.

Moreover, the action performed by the car 313 is detected from the image. The action is determined to establish the risk associated with the detected object. The action is detected from the image and may be established by analysing one or more of the position of the object, the speed of movement of the object, the direction of the object or the like. In particular, with car 313, the movement of the car 313 has been south along road A. As there has been no deviation in the trajectory of car 313, the car 313 is determined to be “Driving Straight”.

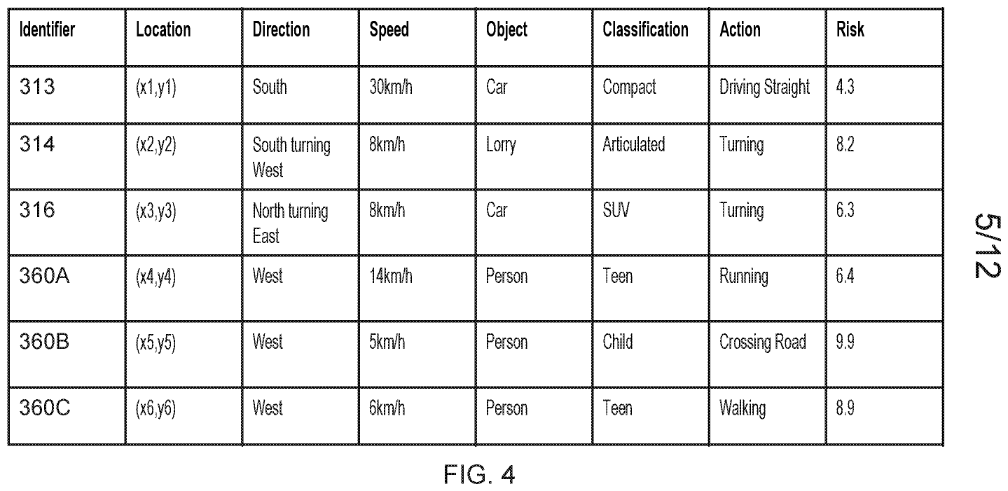

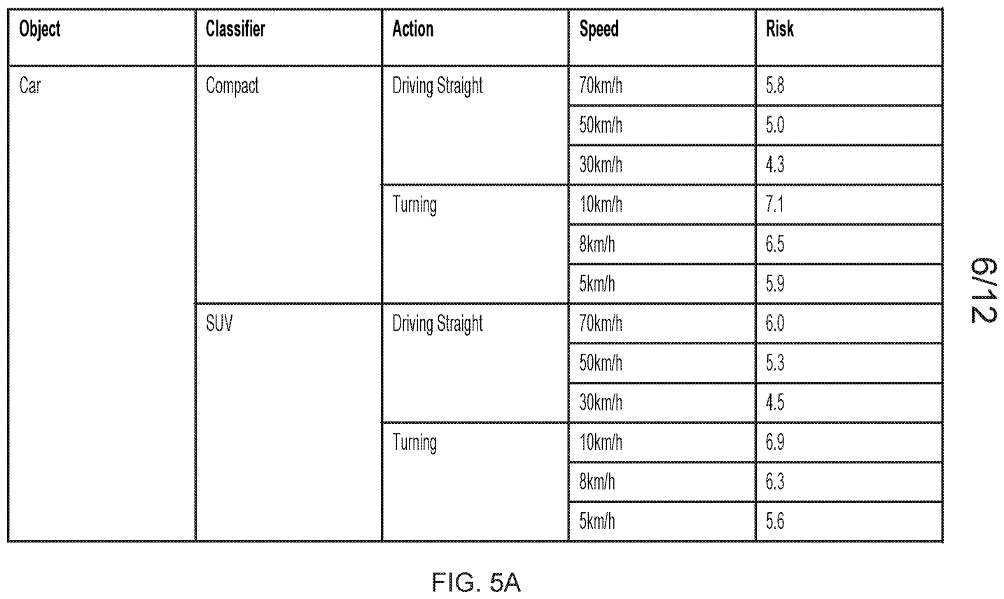

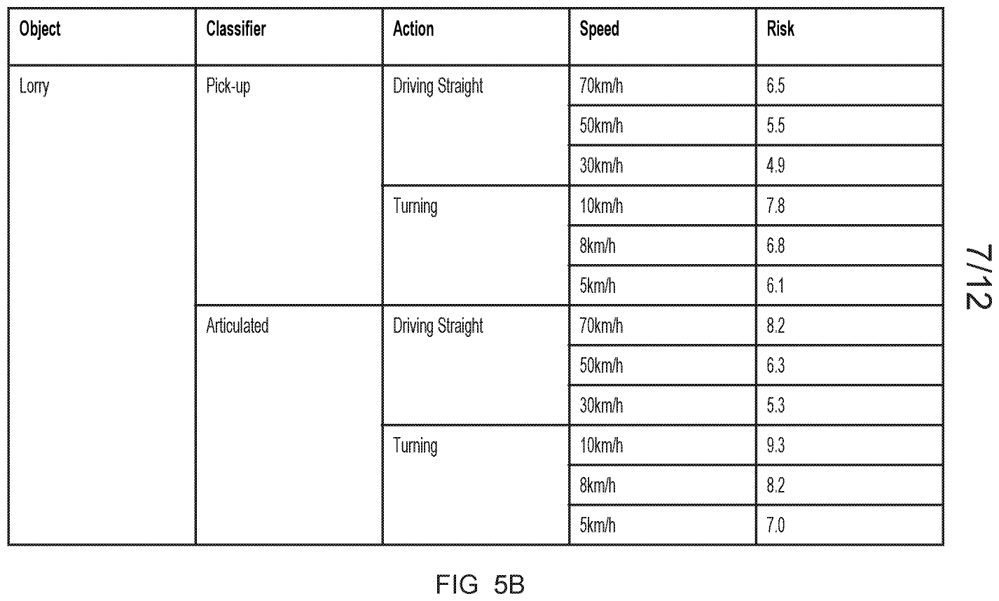

From one or more of the detected parameters of car 313, it is possible to establish a risk metric associated with the object at the particular time. In particular, it is possible to establish a risk metric associated with the car 313 as will be explained later with reference to FIGS. 5A, 5B and 5C.

Returning to the table of FIG. 4, lorry 314 is detected at location (x2, y2). From images captured prior to the predetermined time, the direction of travel of the lorry 314 is changing from South to West. Due to this change in direction it is possible to establish that the lorry is turning. Moreover, given the location of the lorry 314 it is possible to establish that the lorry is turning at the intersection. The speed of the lorry 314 is established as explained with reference to car 313 and the type of the object is detected using the ANPR or using Artificial Intelligence as noted earlier. Again, the value of the risk metric is established using the embodiments explained with reference to FIGS. 5A, 5B and 5C.

Returning to the table of FIG. 4, car 316 is detected at location (x3, y3). From images captured prior to the predetermined time, the direction of travel of the car 316 is changing from North to East. Due to this change in direction it is possible to establish that the car is turning. Again, given the location of this change of direction, it is possible to establish that the car is turning at the intersection. The speed of the car 315 is established as explained with reference to car 313 and the type of object is detected using ANPR or using Artificial Intelligence or the like. Again the risk metric is established using the embodiments explained earlier with reference to FIGS. 5A, 5B and 5C.

Returning to the table of FIG. 4, person 360A is detected at location (x4, y4). From the gait of the detected person 360A and the speed of travel of the person 360A, it is possible to detect that the person 360A is running. Moreover, the classification of the person is a teenager. This is established from the apparent age of the detected person 360A and/or from the proximity of the detected person to the school 305. Moreover, the person 360A may be also wearing a school uniform which indicates the person is a student at the school. In embodiments, the classification of the person is established using Artificial Intelligence.

A second person 360B is detected at location (x5, y5). From the location of the second person 360B, it is possible to establish that the second person 360B is crossing the road. This is further supported by the direction of travel of the second person. Additionally, from the apparent age of the second person 360B and/or from the proximity of the detected second person to the school 305, it is possible to establish that the second person 360B is a child. In embodiments, the classification of the person is established using Artificial Intelligence. The speed of movement of the second person 360B is also established from the images of the second person 360B captured prior to the predetermined time. Moreover, as noted above, the direction of movement of the detected second person indicates that the detected second person is crossing the road. From the parameters explained with reference to FIGS. 5A to 5C it is possible to establish a risk value associated with the detected object (in this case the second detected person).

A third person 360C is detected at location (x6, y6). From the location of the third person 360C, and the speed and direction of movement of the third person, it is possible to establish that the detected third person 360C is walking. Moreover, it is possible to establish that the detected third person 360C is about to cross a road. This is ascertained from the location of the detected third person 360C and the movement of the detected third person. Additionally, from the apparent age of the third person 360C and/or from the proximity of the detected third person to the school 305, it is possible to establish that the third person 360C is a teenager. In embodiments, the classification of the person is established using Artificial Intelligence.

It should be noted that whilst the current movement and location of the third person 360C identifies the person as walking, the direction of travel of the third person 360C and their age profile along with their proximity to school 305 indicates that the third person 360C will cross the road shortly. This allows one or more parameters of a detected object to establish the likely movement of a detected object. As will become apparent later, this future prediction in the movement of the detected third person 360C means that the value of the risk parameter is increased for the detected third person 360C compared with the regular value of the risk parameter for such a detected person. This is because the detected third person is moving into an area which markedly increases their risk. In other words, as the third person is walking towards the edge of a busy road, their risk value increases.

In this instance, it is possible for the audio/video capturing device 100 to issue a warning signal to second device such as a piece of street furniture to issue an audible or visual alert to the detected third person 360C to warn them of the risks associated with crossing a road. In this instance, the warning signal is an audible and/or visual alert. In this alert, information relating to warning such as what dangerous event is considered to be a risk may be provided.

In the same or other embodiments, the audio/video capturing device 100 may issue a warning to a second device in a vehicle (for example the driver of car 317) to warn him or her that the third person 360C may cross the road very soon. Indeed, a similar warning may be issued to drivers approaching the second person 360B to reduce the risk to both the driver and the second person 360B.

FIG. 5A shows a table to establish the value of the risk parameter when the detected object is a car. In particular, in the table of FIG. 5A the value of risk parameter is stored in association with various characteristic features of the detected object. In the embodiments of FIG. 5A, the detected object is a car and for each type of car (the classifier) of compact and SUV, example movements of that car are shown. In the embodiments of FIG. 5A, the actions are driving straight and turning. Of course, other actions or manoeuvres are envisaged such as parking. Moreover, different actions for different types of car are envisaged. For example, a compact car may be able to perform a U-turn whereas a station wagon car may not be able to perform such a U-turn.

One of the parameters associated with each action is speed of the car. This is because speed is one of the main factors associated with risk of an accident and in the event of an accident, the risk to life. In particular, the risk increases as speed increases. In addition, the number of accidents may be a parameter. This may be detected as the number of collisions or by the number of instances of emergency vehicles attending the scene or the trajectory (movement) of the object. The trajectory of the object may include determining whether the object is moving erratically or is not complying with driving laws or the like.

Moreover, although discrete risk values are given for discrete speeds, in embodiments, it is envisaged that there will be a continuum of risk values for all speeds a vehicle may travel. In other words, it is envisaged that the risk value increases gradually from one discrete speed value to another speed value.

It will be noted that the risk value for the same action and the same speed varies depending upon the type of car that is detected. This is because various factors contribute to the risk value. For example, the weight of an SUV is much greater than a compact car which means there is a slightly higher risk to both the occupant of the SUV and pedestrians and other road users in the event of an accident. This means that the risk value is higher for an SUV than for a compact car for driving in a straight line at the same speed.

However, the road position of an SUV is higher than that of a compact. This means visibility for the driver of an SUV is better than that for a compact car. Accordingly, the risk of an SUV crashing whilst turning at low speeds is less than the risk of a compact car crashing. Therefore, the risk value for an SUV is less than a compact for performing a turning manoeuvre at the same speed.

It is envisaged that the risk values are determined for each type of vehicle using experimentation. In particular, it is envisaged that the risk value for each type of vehicle will be comprised of a risk of an accident being caused performing a certain manoeuvre at various speeds and, in the event of an accident, the risk to the occupants of the vehicle, the occupants of other vehicles, pedestrians or street furniture in the event of an accident.

FIG. 5B shows a table to establish the value of the risk parameter when the detected object is a lorry. In particular, in the table of FIG. 5B the value of risk parameter is stored in association with various characteristic features of the detected object. In the embodiments of FIG. 5B, the detected object is a lorry and for each type of lorry (the classifier) of pick-up and articulated, similar to the embodiments of FIG. 5A, example movements of that lorry are shown. In the embodiments of FIG. 5B, the actions are driving straight and turning. As before, other manoeuvres are envisaged and different manoeuvres for different types of vehicle are envisaged.

Similar to the embodiments of FIG. 5A, the embodiments of FIG. 5B have different risk factors at different speeds. This is because speed is one of the main factors associated with the risk of an accident and in the event of an accident, the risk to life.

FIG. 5C shows a table to establish the value of the risk parameter when the detected object is a person. In particular, in the table of FIG. 5C, the value of risk parameter is stored in association with various characteristic features of the detected object. In the embodiments of FIG. 5C, the detected object is a person and for each type of person (the classifier) of teen and child are shown. Of course, other types of person are envisaged. In some embodiments the type of person will be defined by their age profile such as elderly, adult or the like or may be defined by their mobility such as highly mobile, mobile or infirm or the like.

In the table of FIG. 5C, the risk associated with a teen and child running, walking and crossing a road is shown. As will be appreciated, the speed at which a child and teen can run varies due to the size difference between a teen and a child. Moreover, a child running at a high speed is likely to be of higher risk of injury than a teen running at a high speed due to a child having a higher risk of falling over. Moreover, the risk to a child when crossing a road is higher than a risk to a teen due to the lack of experience a child has at crossing a road compared to a teenager. Moreover, it will be noted that there is an optimum speed for crossing a road: if a person crosses a road at a high speed, they are more likely to fall thus causing injury. However, if they cross the road too slowly, they are more likely to collide with a vehicle which increases the risk associated with crossing a road.

As will be appreciated, all movement around a location of a pedestrian or vehicle will involve some risk. In other words, there is always a risk with any movement of an object at a location. However, in the instance that a risk value is above a predetermined value, the audio/video capturing device 100 is in embodiments configured to mitigate (i.e. reduce) the risk to below the predetermined value. This may be achieved in numerous ways. However, in embodiments, an instant mitigation may be applied. As explained earlier, in order to apply an instant mitigation, the audio/video capturing device 100 may send a warning signal to street furniture near to the location of the object subject to the excessive risk. So, in the example of the risk factor being a child crossing the road, as explained earlier, the audio/video capturing device 100 may issue a warning signal to a second device such as a piece of street furniture like a street lamp that may issue a visible or audible alert or the child warning them of the risk when the risk value is above a predetermined threshold value. In embodiments, the predetermined threshold value when a warning is issued may be the same value or a different value to the predetermined value when mitigation is provided.

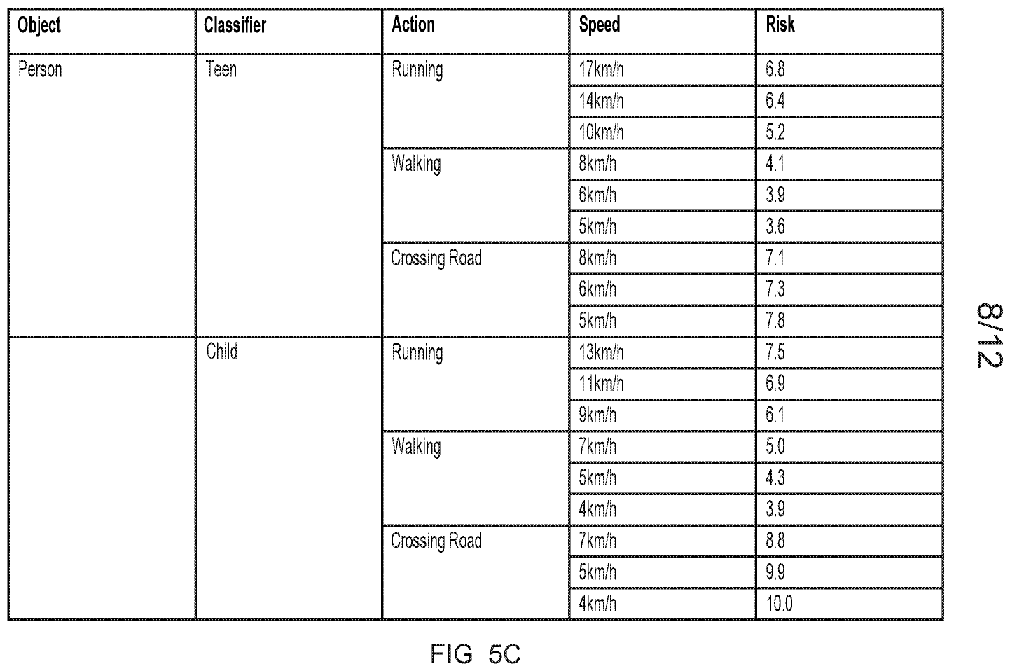

However, in embodiments, a more permanent mitigation may be provided. The permanent mitigation may be selected when requested by a user or may be selected in the event of a fatality caused by an accident at a location or where the number of occurrences of the risk values exceeding a predetermined threshold is at or above a certain level. The selection of a permanent risk mitigation will now be explained with reference to FIG. 6.

In FIG. 6, three permanent mitigation techniques are described. The first is the installation of a crossing, the second is the installation of traffic lights and the third is installation of a refuge island. Clearly other permanent mitigation techniques are envisaged such as speed reduction humps, installation of speed cameras, installation of one way systems, parking restrictions or the like. In instances, traffic lights and/or road markings may also be permanent mitigation techniques.

In FIG. 6, each mitigation technique is associated with an action whose risk is mitigated by the installation of the permanent technique and the amount of risk reduction associated with the mitigation technique. So, in the example of FIG. 6, the installation of the crossing reduces the risk of crossing the road by 3.1, the installation of the traffic light reduces the risk of turning by 4.5 as oncoming traffic is stopped and a refuge island (where a pedestrian may wait as they cross the road) reduces the risk of crossing the road by 1.1.

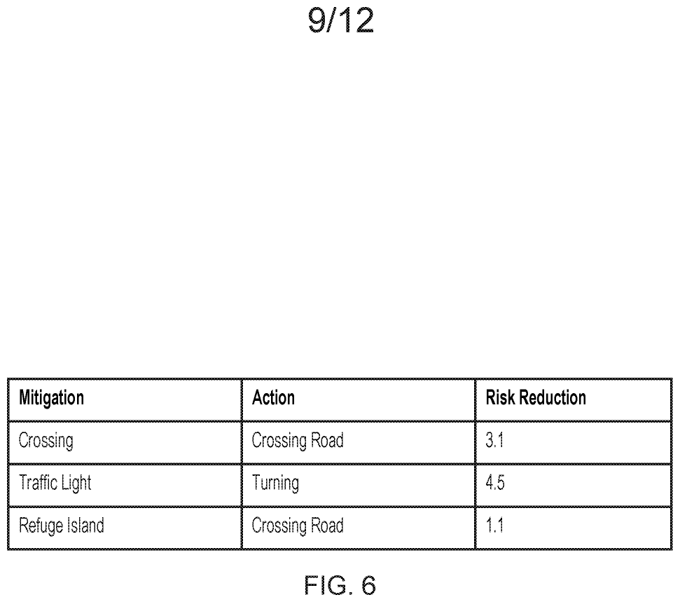

So, in the example of FIG. 4, in the event that the threshold of the risk value is 8.5, the second detected person 360B and the third detected person exceeds the threshold. Accordingly, in the event that a user has instructed a permanent mitigation be provided, the crossing road action needs mitigating. Therefore, from FIG. 6, it is possible to install a pedestrian crossing or a refuge island. However, in order to meet the accepted risk value of 8.5, the refuge island does not mitigate the risk enough. Accordingly, a pedestrian crossing should be selected. This reduces the risk by 3.1 and thus meets the threshold risk value. The installation of the pedestrian crossing 710 is shown in FIG. 7 by arrangement 700 that shows FIG. 2B with the selected risk mitigation installed.

Although the foregoing shows the installation of a permanent pedestrian crossing to mitigate the risk to the pedestrian, the disclosure is not so limited. In embodiments, a temporary pedestrian crossing may be installed to mitigate the risk at a particular time during the day or for a particular event. As explained above, a school 305 is shown and a bus stop 350 is located across the street from the school 305. This means that at two periods during the day, there will be many children (either child or teen) will be moving between the school 305 and the bus stop 350. During other times of the day, there may be limited numbers of people crossing the road. Therefore, a permanent pedestrian crossing 710 may be excessive to mitigate the risk as the pedestrian crossing 710 will be in situ all day and on every day. Accordingly, a temporary pedestrian crossing may be a more suited risk mitigation choice. The temporary pedestrian crossing may be provided by shining an appropriate image on the road surface at times when the number of children arriving for school 305 or leaving the school 305 is above a certain threshold number. In other instances, a variable message road sign embodied as a Light Emitting Diode display or a dot-matrix variable message sign may be used to provide a temporary risk mitigation such as a temporary pedestrian crossing.

Although the foregoing describes determining the risk value at a specific time, it will be appreciated that the risk value at a particular location will change during the day. For example, during rush hour, the risk value may increase as traffic and pedestrian density increases. Embodiments of the present disclosure provides a real-time risk value by capturing and analysing images from a particular location in real-time.

Although the foregoing has been used to improve safety of people in a smart city, the disclosure is not so limited. For instance, the risk values may be used by companies to determine the location of shops and outlets. In particular, companies may wish to locate new shops in areas where the risk to pedestrians and drivers is below a certain level.

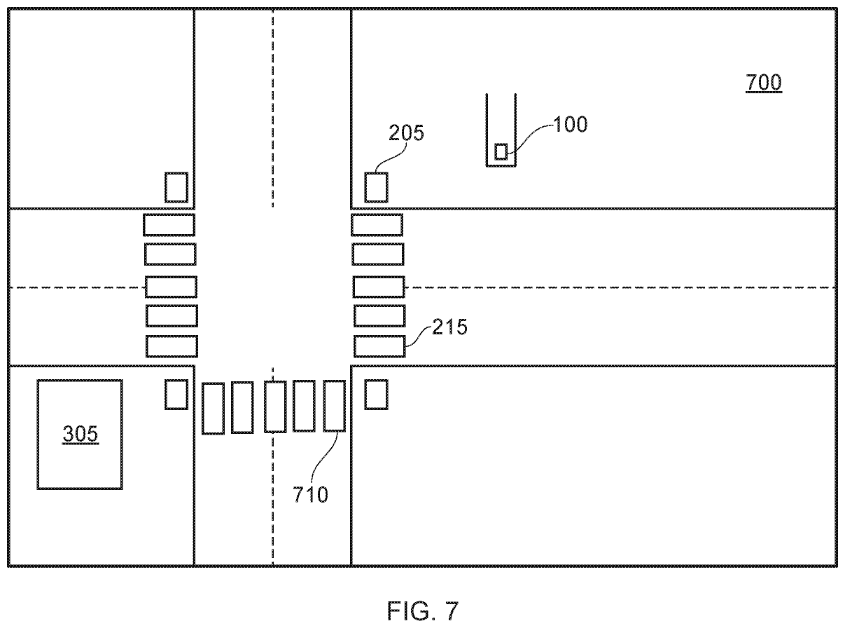

FIG. 8 shows a central control system 800 according to embodiments of the disclosure. As noted above, the central control system 800 controls a smart city.

The central control system 800 includes central control system processing circuitry 805 that controls the operation of the central control system 800.

The central control system processing circuitry 805 may be formed from semiconductor material and may be an Application Specific Integrated Circuit or may operate under the control of software. In other words, the central control system processing circuitry 805 may operate under the control of software instructions stored on central control system storage medium 815.

Additionally connected to the central control system processing circuitry 805 is the central control system storage 815. The central control system storage 815 may be semiconductor storage or optically or magnetically readable storage. The central control system storage 815 is configured to store software code according to embodiments therein or thereon.

The central control system 800 also includes central control system communication circuitry 820. The central control system communication circuitry 820 is connected to the central control system processing circuitry 805 and is configured to receive, over a network, the table of FIG. 4. This will be received from the audio/video capturing device 100. In this case, the central control system 800 will be part of a system including the audio/video capturing device 100. Of course, the disclosure is not limited to this and other data may be provided over the network by central control system communication circuitry 820. The network may be a wired network, or a wireless network. For example, the central control system communication circuitry 820 may allow data to be communicated over a cellular network such as a 5G network, or a Low Earth Orbit Satellite internet network or the like. This network may be a Wide Area Network such as the Internet or may be a Private Network.

Although the central control system communication circuitry 820, central control system processing circuitry 805 and central control system storage 815 is described as functionally different, it is envisaged that, in embodiments, these may all form part of the same circuitry. In other words, the central control system 800 may comprise circuitry to perform the various functional steps.

In embodiments, the central control system storage 815 may store the risk value tables shown in FIGS. 5A, 5B and 5C and the mitigation table of FIG. 6. In other embodiments, the risk value table shown in FIGS. 5A, 5B and 5C may be stored in the audio/video capturing device 100 which means the risk value may be determined within the audio/video capturing device 100. The central control system 800 may then be notified of an occurrence of the risk value exceeding the threshold value. In embodiments, the central control system 800 may be notified by the audio/video capturing device 100 of the warning signal and the central control system 800 may notify the appropriate piece of street furniture. Similarly, a user of the central control system 800 may request that mitigation reduction be carried out or the central control system 800 may request that mitigation reduction be carried out automatically. The mitigation reduction explained with reference to FIG. 6 will then be carried out by either the audio/video capturing device 100 or the central control system 800.

Although the above describes the audio/video capturing device 100 carrying out the object detection, the disclosure is not so limited. In embodiments, the audio/video capturing device 100 performs image capturing only and sends the captured image to the central control system 800. The central control system 800 then performs the object detection and risk calculation. In this instance, in embodiments, the image is anonymised prior to be being sent to the central control system 800 to remove individuals from the image.

Although the foregoing describes various scenarios and corresponding mitigations, the disclosure is not limited to these. The table below shows more example scenarios and corresponding mitigations.

| Scenario | Mitigation |
|---|---|
| Number of people crossing | Insert pedestrian crossing |
| road above a first | to provide safe crossing |
| threshold | area for pedestrians |
| Number of people crossing | Remove pedestrian crossing |
| road at a pedestrian | to improve traffic flow |
| crossing is less than | |
| a second threshold | |
| Number of vehicles not | Insert traffic enforcement |
| stopping at the | camera or move the |
| pedestrian crossing | pedestrian crossing to |
| while pedestrian | another location |
| is crossing is above a | |
| third threshold | |
| Number of vehicles | Insert speed enforcement |
| driving above the speed | camera or change speed |
| limit in proximity of | limit |
| pedestrian crossing is | |
| above a fourth threshold | |
| Number of vehicle-pedestrian | Increase risk index value |
| accidents is above a | and urgently inform city |
| fifth threshold | administration |
| Number of near vehicle | Decrease the speed limit |
| collisions is above a sixth | |
| threshold (this may be | |
| determined by the number | |
| of high deceleration events) | |
| Number of vehicles not | Add speed bumps and make |
| respecting the road signs | traffic signs more |
| such as give way to the | evident |
| right, red lights on traffic | |
| lights, stop signs or the | |
| like. | |
| Traffic sign not | Notify road maintenance |
| visible anymore | |

Although the foregoing has described various parameters of the or each object upon which the risk for a particular object is determined. These parameters relate to the object itself. However, the disclosure is not so limited. For example, the parameter may relate to other objects near the object for which a risk is determined such as the number of other objects near its location. This has an impact on the risk associated with the object such as the number of people crossing the road at a particular time or the number of children near the location of the object. Indeed, if the object is a person, the number of other people crossing the road with the person may impact the risk associated with the person as they may trip or collide with one or more other person which would increase their risk.

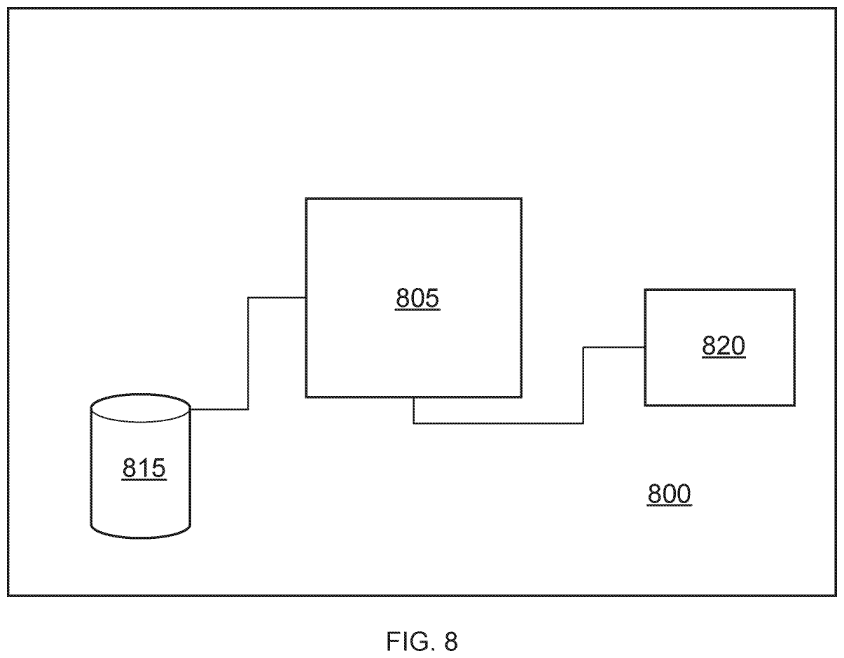

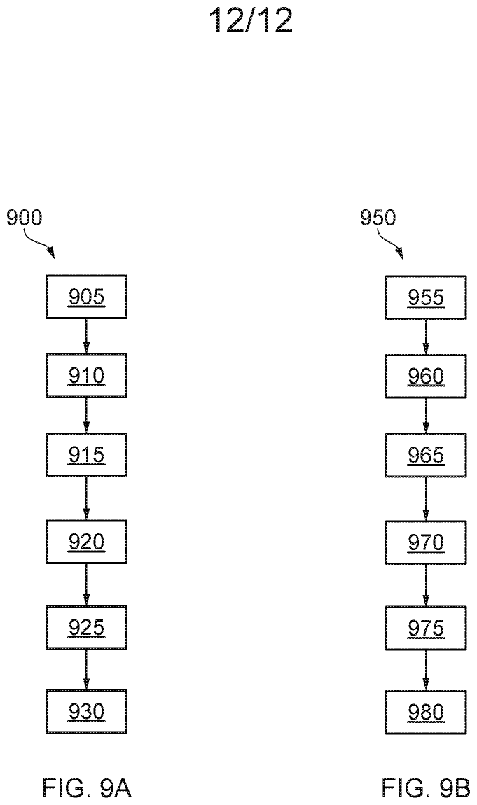

FIG. 9A shows a method 900 carried out in the audio/video capturing device 100 according to embodiments. The process starts in step 905. The process then moves to step 910 where data from an image of the location captured by a camera is received. In this case, the data is the image captured by the image sensor, such as the RAW image or the like. The process then moves to step 915 where the presence of one or more objects in the image is determined from the data. The process then moves to step 920 where a plurality of parameters for each of the objects in the image is determined. The process then moves to step 925 where the risk value based upon the plurality of parameters is determined. The process then stops in step 930.

FIG. 9B shows a method 950 carried out in the central control system 800 according to embodiments. The process starts in step 955. The process then moves to step 960 where data from an image of the location captured by a camera is received. In this case, the data is metadata associated with the image captured by the audio/video capturing device 100 or anonymised image data. The process then moves to step 965 where the presence of one or more objects in the image is determined from the data. The process then moves to step 970 where a plurality of parameters for each of the objects in the image is determined. The process then moves to step 975 where the risk value based upon the plurality of parameters is determined. The process then stops in step 980.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present technique can generally described by the following numbered clauses:

1. A method of determining a risk value at a real-world location, the method comprising:
receiving data from an image of the location captured by a camera;
determining, from the data, the presence of one or more objects in the image;
determining a plurality of parameters for each of the objects in the image; and
determining the risk value based upon the plurality of parameters.

2. A method according to clause 1, further comprising:
providing a warning signal to a second device in the event that the risk value is above a threshold value.

3. A method according to clause 2, wherein the warning signal is an audible and/or visual alert.

4. A method according to any one of clause 1, 2 or 3, wherein one of the plurality of parameters is selected from the speed of the object, change of speed of the object, the number of accidents at the location of the object, the number of people crossing the road at the location of the object, the number of children at the location or trajectory of the object.

5. A method according to any one of the preceding clauses, wherein in the event that the risk value is above a predetermined value, the method further comprises: selecting from a set of mitigation actions, one or more mitigation action that reduces the risk value.

6. A method according to clause 5, comprising reducing the risk value to below the predetermined value.

7. A method according to clause 5 or 6, wherein the one or more mitigation action is a permanent mitigation action.

8. A method according to clause 7, wherein the one or more permanent mitigation action is selected from a set consisting of the installation of a crossing, the installation of traffic lights or the installation of a refuge island.

9. A method according to any preceding clause wherein the data is image data or metadata.

10. A device for determining a risk value at a real-world location, the device comprising circuitry configured to:
receive data from an image of the location captured by a camera;
determine, from the data, the presence of one or more objects in the image;
determine a plurality of parameters for each of the objects in the image; and
determine the risk value based upon the plurality of parameters.

11. A device according to clause 10, wherein the circuitry is configured to:
provide a warning signal to a second device in the event that the risk value is above a threshold value.

12. A device according to clause 11, wherein the warning signal is an audible and/or visual alert.

13. A device according to any one of clause 10, 11 or 12, wherein one of the plurality of parameters is selected from the speed of the object, change of speed of the object, the number of accidents at the location of the object, the number of people crossing the road at the location of the object, the number of children at the location or trajectory of the object.

14. A device according to any one of clauses 10 to 13, wherein in the event that the risk value is above a predetermined value, the circuitry is configured to: select from a set of mitigation actions, one or more mitigation action that reduces the risk value.

15. A device according to clause 14, wherein the circuitry is configured to: reduce the risk value to below the predetermined value.

16. A device according to clause 14 or 15, wherein the one or more mitigation action is a permanent mitigation action.

17. A device according to clause 16, wherein the one or more permanent mitigation action is selected from a set consisting of the installation of a crossing, the installation of traffic lights or the installation of a refuge island.

18. A device according to any one of clauses 10 to 17 wherein the data is image data or metadata.

19. A device according to any one of clauses 10 to 18, comprising the camera used to capture the image.

20. A system comprising a device according to clause 11 and the second device, wherein the second device is selected from a list consisting of a piece of street furniture or a vehicle.

21. A computer program product comprising computer readable instructions which, when loaded onto a computer, configures the computer to perform a method according to any one of clauses 1 to 9.

1. A method of determining a risk value at a real-world location, the method comprising:
receiving data from an image of the location captured by a camera;
determining, from the data, the presence of one or more objects in the image;
determining a plurality of parameters for each of the objects in the image; and
determining the risk value based upon the plurality of parameters, wherein in the event that the risk value is above a predetermined value, the method further comprises: selecting from a set of mitigation actions, one or more mitigation action that reduces the risk value to below the predetermined value,
wherein one of the plurality of parameters is selected from the speed of the object, change of speed of the object, the number of accidents at the location of the object, the number of people crossing the road at the location of the object, the number of children at the location or trajectory of the object

2. The method according to claim 1, further comprising:
providing a warning signal to a second device in the event that the risk value is above a threshold value.

3. The method according to claim 2, wherein the warning signal is an audible and/or visual alert.

4. (canceled)

5. (canceled)

6. The method according to claim 1, wherein the one or more mitigation action is a permanent mitigation action.

7. The method according to claim 6, wherein the one or more permanent mitigation action is selected from a set consisting of the installation of a crossing, the installation of traffic lights or the installation of a refuge island.

8. The method according to claim 1 wherein the data is image data or metadata.

9. A device for determining a risk value at a real-world location, the device comprising circuitry configured to:
receive data from an image of the location captured by a camera;
determine, from the data, the presence of one or more objects in the image;
determine a plurality of parameters for each of the objects in the image; and
determine the risk value based upon the plurality of parameters, wherein in the event that the risk value is above a predetermined value, the circuitry is configured to: select from a set of mitigation actions, one or more mitigation action that reduces the risk value.

10. The device according to claim 9 wherein the circuitry is configured to:
provide a warning signal to a second device in the event that the risk value is above a threshold value.

11. The device according to claim 10, wherein the warning signal is an audible and/or visual alert.

12. The device according to claim 9, wherein one of the plurality of parameters is selected from the speed of the object, change of speed of the object, the number of accidents at the location of the object, the number of people crossing the road at the location of the object, the number of children at the location or trajectory of the object.

13. The device according to claim 9, wherein in the event that the risk value is above a predetermined value, the circuitry is configured to: select from a set of mitigation actions, one or more mitigation action that reduces the risk value.

14. The device according to claim 13, wherein the circuitry is configured to: reduce the risk value to below the predetermined value.

15. The device according to claim 13, wherein the one or more mitigation action is a permanent mitigation action.

16. The device according to claim 15, wherein the one or more permanent mitigation action is selected from a set consisting of the installation of a crossing, the installation of traffic lights or the installation of a refuge island.

17. The device according to claim 9, wherein the data is image data or metadata.

18. The device according to claim 9, comprising the camera used to capture the image.

19. A system comprising the device according to claim 10, and the second device, wherein the second device is selected from a list consisting of a piece of street furniture or a vehicle.

20. A non-transitory computer readable medium storing computer readable instructions which, when loaded onto a computer, configures the computer to perform the method according to claim 1.
